(19) United States
(12) Patent Application Publication
(10) Pub. No.: US 2014/0193166 A1
(43) Pub. Date: Jul. 10, 2014

(54) IMAGE FORMING APPARATUS

(71) Applicants: Toshiba Tec Kabushiki Kaisha, Tokyo (JP); Kabushiki Kaisha Toshiba, Tokyo (JP)

(72) Inventor: YASUHARU ARIMA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 14/150,538

(22) Filed: Jan. 8, 2014

(30) Foreign Application Priority Data
Jan. 8, 2013 (JP) 2013-001281

(51) Int. Cl. G03G 15/08

(52) U.S. Cl. CPC G03G 15/0824
USPC 399/27

(57) ABSTRACT

An image forming apparatus includes a latent image forming section configured to form an electrostatic latent image on an image carrying body based on a print job including a number of sheets to be printed and a pixel count. A developing device develops the electrostatic latent image with a two-component developer containing toner and a carrier. A toner transporting section transports replenishment toner to the developing device. A toner replenishment time is based on the pixel count of the print job, and a job duration is based on the number of sheets to be printed. A drive control section controls transportation of replenishment toner during each of a plurality of divided replenishment times. The total of the plurality of divided replenishment times is equal to the toner replenishment time, and the plurality of divided replenishment times are uniformly spread across the job duration.

### CROSS-REFERENCE TO RELATED APPLICATION

This application is based upon and claims the benefit of priority from Japanese Patent Application No. 2013-001281, filed Jan. 8, 2013, the entire contents of which are incorporated herein by reference.

### FIELD

An embodiment described herein relates generally to an image forming apparatus.

### BACKGROUND

Toner, which is in powder form, sometimes produces a lump due to agglomeration. For development control, the toner is conveyed while being agitated to crush the lamps that may have been formed, so that the uniformity of the toner concentration in a developing device can be maintained.

For toner replenishment control, the toner concentration in a developer has to be made uniform, and an image stabilizing device that controls the amount of toner to be added to a toner replenishing device according to the rate of printing a manuscript is known. An image forming apparatus that performs divided replenishment by which a predetermined amount is added at predetermined intervals is also known.

However, in the replenishment control of the existing techniques, agitation performed inside a small developing container becomes inadequate and the toner concentration may not be adequately stabilized. When this happens, the image forming apparatus suspends printing and performs toner forced replenishment operation. As a result, the printing performance can be degraded as compared to the original printing performance.

### DESCRIPTION OF THE DRAWINGS

FIG. 1 is a diagram of an image forming apparatus according to an embodiment;

FIG. 2 is a diagram depicting an example of placement of a latent image forming section, a toner cartridge, and a toner transporting section of the image forming apparatus according to the embodiment;

FIG. 3 is a block diagram depicting a control system including a drive control section of the image forming apparatus according to the embodiment;

FIG. 4 is a flowchart depicting an example of calculation performed by a calculating section of the image forming apparatus according to the embodiment;

FIG. 5 is a time chart indicating periods of time for performing toner replenishment according to the embodiment; and

FIG. 6 is a time chart for describing divided replenishment operation performed by an image forming apparatus according to a modified example of the embodiment.

### DETAILED DESCRIPTION

An image forming apparatus according to an embodiment includes a latent image forming section configured to form an electrostatic latent image on an image carrying body based on image data of a print job including a number of sheets to be printed for the print job and a pixel count of the print job, and a developing device configured to develop the electrostatic latent image with a two-component developer containing toner and a carrier. The image forming apparatus includes a toner cartridge configured to provide replenishment toner to the developing device, and a toner transporting section configured to transport replenishment toner from the toner cartridge to the developing device. The image forming apparatus also includes a calculating section configured to calculate a toner replenishment time required for the toner transporting section to transport the replenishment toner to the developing device based on the pixel count of the print job, and to calculate a job duration of the print job based on the number of sheets to be printed. The image forming apparatus also includes a drive control section configured to control, the toner transporting section to transport replenishment toner during each of a plurality of divided replenishment times, wherein the total of the plurality of divided replenishment times is equal to the toner replenishment time calculated by the calculating section, and the plurality of divided replenishment times are uniformly spread across the job duration.

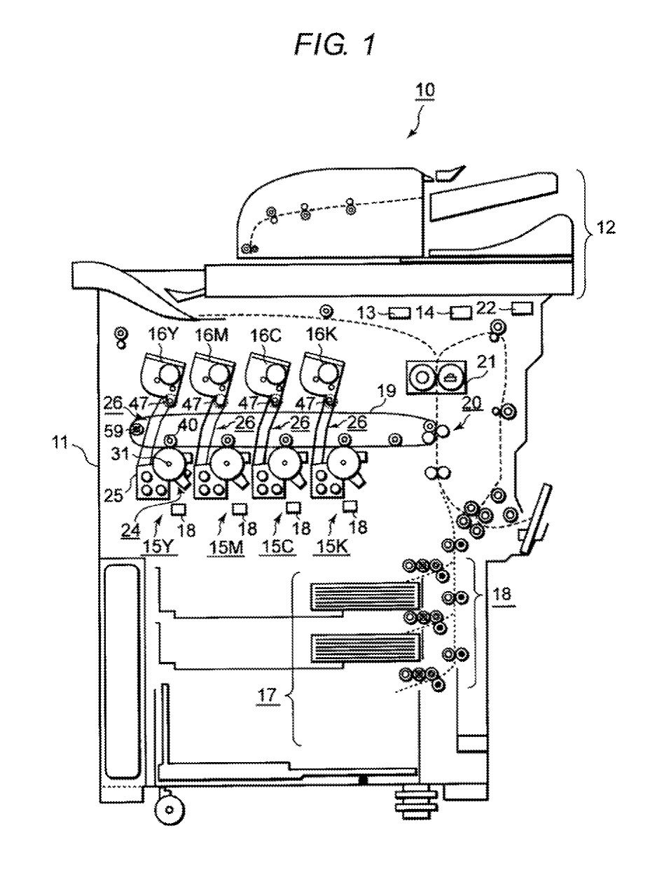

Hereinafter, an image forming apparatus according to an embodiment will be described with reference to FIGS. 1 to 6. In the figures, identical portions in the drawings are identified with common characters and overlapping explanations will be omitted.

FIG. 1 is a diagram of the image forming apparatus according to the embodiment. An MFP 10 has a main body 11 provided with a scanner section 12 that scans a manuscript surface in color, an image processing section 13 that corrects four-color image data, and a line memory 14 that stores line data of four colors. The MFP 10 includes an image forming section 15Y for yellow (Y), an image forming section 15M for magenta (M), an image forming section 15C for cyan (C), and an image forming section 15K for black (K), each performing formation of a latent image on a photoconductor 23 (an image carrying body) and development. The MFP 10 includes toner cartridges 16Y, 16M, 16C, and 16K containing replenishment toner of the respective colors. The MFP 10 further includes a paper feeding section 17 with trays in which paper is set and a conveyance mechanism 13 that feeds the paper from the paper feeding section 17 to a secondary transfer position. The MFP 10 includes a secondary transferring section 20 that transfers a form-color toner image on an endless traveling belt 19 onto the paper, a fuser 21 that fuses the toner image that is yet to he fused, and a controller 22 that performs main control.

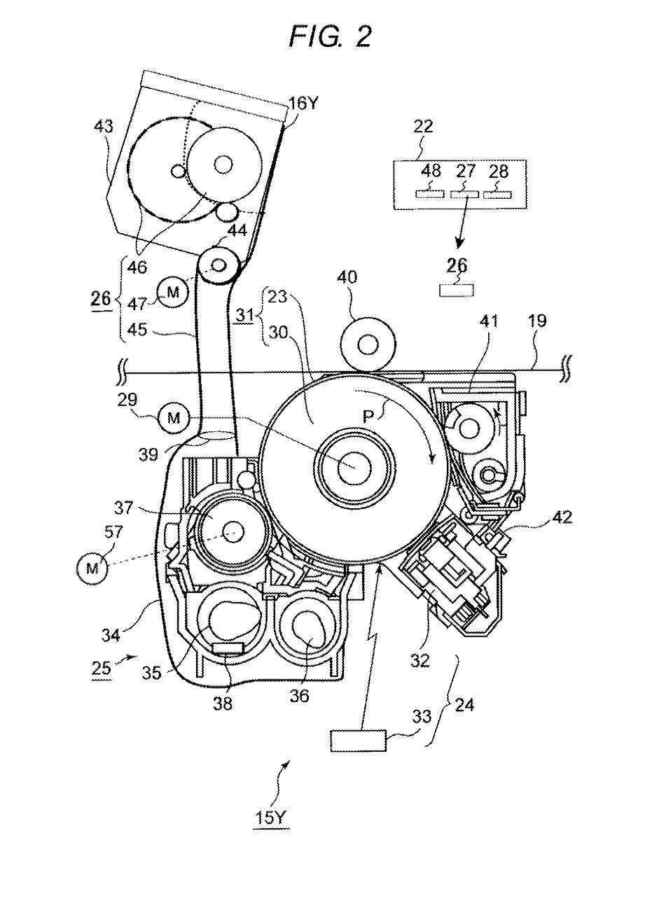

FIG. 2 is a diagram depicting an example of placement of a latent image forming section, the toner cartridge 16Y, and a toner transporting section 26 of the image forming section 15Y for yellow. A similar arrangement is repeated for magenta, cyan and black. The MFP 10 includes a latent image forming section 24 that forms an electrostatic latent image on the photoconductor 23 by exposing the surface of the photoconductor 23 to light based on yellow image data in a print job containing image data, the number of sheets to be printed, and a pixel count of printing. The image forming section 24 also includes a developing device 25 that develops the electrostatic latent image formed by the latent image forming section 24 by a two-component developer containing toner and a carrier. The MFP 10 further includes the toner cartridge 16Y containing yellow replenishment toner that is fed into the developing device 25 and the toner transporting section 26 that transports the yellow replenishment toner from the toner cartridge 16Y to the inside of the developing device 25.

The MFP 10 further includes a pixel counter 48 in the controller 22. The MFP 10 includes a calculating section 27 that obtains a total toner replenishment time length required for a print job by the toner transporting section 26 based on a pixel count obtained by the pixel counter 48. The calculating section 27 also obtains a job duration time of the print job based on the number of sheets to be printed. The MFP 10 farther includes a drive control section 28 that equally divides the toner replenishment time length into uniform intervals across the job duration time. The drive control section also makes the toner transporting section 26 execute divided replenishment in a plurality of periods of time of the same length of time.

The toner replenishment time length refers to a drive time of a toner replenishment motor 47 (a motor) for securing in advance the needed amount of toner for printing all the pixels of one print job. A pixel refers to a unit that forms image data of a yellow component, for example, and is represented by one dot or a plurality of dots. A dot of a yellow component refers to a small circle close to a point formed with yellow toner on the paper. The divided replenishment refers to performing replenishment of a small amount of toner more than once.

The latent image forming section 24 includes a photoconductor drum 31 that has a drum 30 rotated by a arum motor 29 and the photoconductor 23. The drum 30 rotates in a direction indicated with an arrow P. The latent image forming section 24 also includes a charging device 32 that charges the surface of the photoconductor 23, and an exposure device 33 that forms an electrostatic latent image on the charged photoconductor 23.

The developing device 25 includes a container 34 that is filled with a two-component developer, mixers 35 and 36 and a magnet roller 37 that are provided in the container 34, and a toner sensor 38 that senses the concentration of the toner in the developer agitated by the mixers 35 and 36. The container 34 has a toner reception mouth 39 in an upper part of an inner chamber of the container 34. The reception mouth 39 is connected to the toner transporting section 26. The developing device 25 is supplied with toner (replenishment toner) from the toner cartridge 16Y. The toner sensor 38 may be, for example, an automatic toner sensor (ATS).

The image forming section 15Y includes the latent image forming section 24, the developing device 25, a primary transfer roller 40, a cleaner 41, and a static eliminator 42. The primary transfer roller 40 transfers a toner image onto the belt 19 which is an object on which transfer is performed. The cleaner 41 removes residual toner from the photoconductor 23 by scraping. The static eliminator 42 removes the charges on the photoconductor drum 31. The exposure device 33 performs exposure by using a light emitting diode (LED), for example.

The toner cartridge 16Y contains yellow toner (replenishment toner) for the developing device 25. The toner cartridge 16Y has a cartridge case 43 and a toner outlet 44 provided in the cartridge case 43. The outlet 44 faces the reception mouth 39 of the developing device 25.

The toner transporting section 26 includes a tubs 45 connected to the outlet 44 and the reception mouth 39 of the developing device 25, a rotary agitation member 46 that feeds the toner into the tube 45 through the outlet 44 in the cartridge case 43, and a toner replenishment motor 47 that rotates the rotary agitation member 46. The toner is pushed from the outlet 44 and enters the reception mouth 39 after passing through the tube 45. The rotary agitation member 46 is formed of an anger and a paddle provided in the cartridge case 43. The auger has a spiral blade. The rotation ox the paddle is linked to the rotation of the auger. As the toner replenishment motor 47, a stepping motor is used.

The amount of toner to be transported by the toner transporting section 26 per hour (i.e., the rate of toner replenishment) is estimated in advance based on the inside diameter of the tube 45, the amount of toner to be discharged and transported by one rotation of the rotary agitation member 46, and the rotation angular speed of the toner replenishment motor 47. The rate of toner replenishment is measured by an experiment or a test using a re-created mechanism portion of the toner transporting section 26, for example. The consumption of toner required for printing all the pixels contained in one print job is controlled by the drive time of the toner replenishment motor 47 with a known amount of toner to be transported.

Moreover, in FIG. 1, the latent image forming section 24 for magenta, the latent image forming section 24 for cyan, and the latent image forming section 24 for black are virtually identical to the latent image forming section 24 for yellow in structure. The structure of the image forming sections 15M, 15C, and 15K is virtually identical to the structure of the image forming section 15Y. The toner cartridge 16M and the toner transporting section 26 for magenta, the toner cartridge 16C and the toner transporting section 26 for cyan, and the toner cartridge 16K and the toner transporting section 26 for black are virtually identical to the toner cartridge 16Y and the toner transporting section 26 for yellow in structure. The amount of toner to foe transported is measured in advance for each of the four toner colors.

The calculating section 27 (FIG. 2) calculates a toner replenishment time length for the job duration time of the print job before the print job is started. The job duration time refers to the length of time from the start of one print job to the end thereof. The controller 22 generates a print job by using the scanner section 12. Alternatively, a print job is a print job received by the controller 22, the print job containing rasterized image data transmitted from a personal computer, for example, via a communication cable. The calculating section 27 holds in advance the information about the amount of toner to be transported by the toner transporting section 26 per unit time and may calculate a toner replenishment time length from the information about the amount of toner to be transported.

The drive control section 28 controls toner divided replenishment. The drive control section 28 equally divides a toner replenishment time length over the total time for each print job. The drive control section 28 performs the division calculation before printing. The drive control section 28 controls the toner transporting section 26 based on the information on an ON period of transportation operation performed by the toner transporting section 26 in the plurality of periods of time obtained by equally dividing the toner replenishment time length and an OFF period of the operation. The number of times ON and OFF of the operation are repeated in a toner replenishment time length. Both the calculating section 27 and the drive control section 28 are implemented by a central processing unit (CPU), read-only memory (ROM), and random-access memory (RAM).

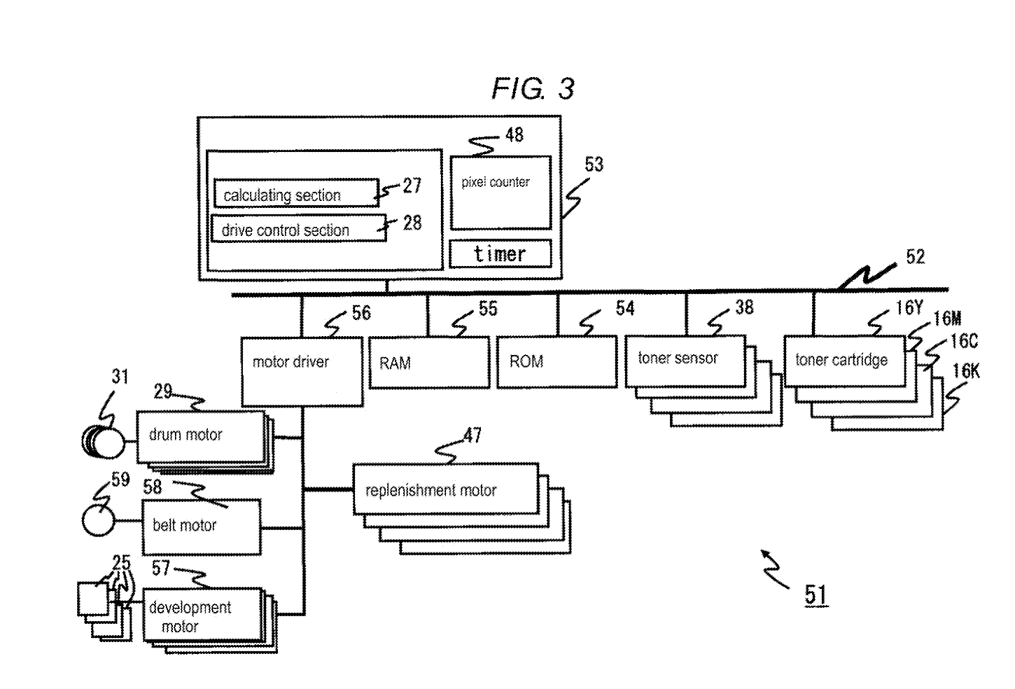

FIG. 3 is a block diagram depicting a control system focused on a control function of toner divided replenishment performed by the drive control section 28. The already-described characters represent the same elements as those identified with these characters.

A control system 51 includes a bus 52, a CPU 53, ROM 54, and RAM 55. The CPU 53 has a pixel counter 48 (a counter) that stores pixel count information and hardware for a computation. The CPU 53 extracts pixel count information contained in one print job from the print job and sets the pixel count information in the pixel counter 48. The CPU 53 sets and resets the value of the pixel counter 48 for each print job. The ROM 54 stores the value of the amount of toner to be transported and a value and a parameter which are required for divided replenishment control. The RAM 55 stores a program for executing a calculation function and a drive control function performed by the CPU 53. The control system 51 includes a motor driver 56 that controls the rotation of each motor: four toner replenishment motors 47, four drum motors 29 that rotate the photoconductor drums 31, a belt motor 58 that rotates a roller 59, and four development motors 57, each rotating one or both of the mixers 35 and 36 and the magnet roller 37. Furthermore, the control system 51 detects whether or not the toner concentration values detected by the toner sensors 38 provided for the four colors are within a set range. The control system 51 may detect whether or not the toner cartridges 16Y, 16M, 16C, and 16K are empty.

In the MFP 10 configured as described above, when a manuscript is set, the scanner section 12 reads an image on the manuscript surface. The image processing section 13 generates four-color image data. The exposure devices 33 of the image forming sections 16Y, 16M, 16C, and 16K generate electrostatic latent images for four colors on the photoconductor drums 31. Each developing device 25 holds the toner on the outer circumferential surface of the magnet roller 37. The developing device 25 supplies the toner to the electrostatic latent image by a magnetic brush and develops the electrostatic latent image. The primary transfer roller 40 for yellow performs primary transfer of the yellow toner image on the photoconductor drum 31 onto the belt 19. As a result of traveling of the belt 19, the primary transfer rollers 40 for magenta, cyan, and black sequentially perform primary transfer of the toner images of different color components onto the belt 19. The secondary transferring section 20 biases the paper and transfers, onto the paper, the toner image obtained as a result of the four color components being superimposed on one another. The fuser 21 fuses the toner image onto the paper. As a result of color printing, toner of four colors is consumed.

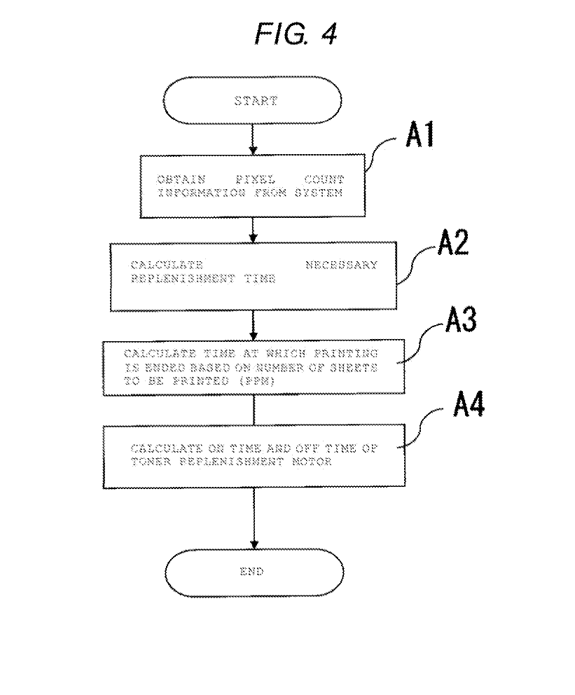

FIG. 4 is a flowchart depicting an example of calculation for equal replenishment of toner including the calculation of the toner replenishment time length performed by the calculating section 27 of the MFP 10. The calculating section 27 starts executing the processing in FIG. 4 when each print job is generated and queued by the controller 22. An example in which the MFP 10 performs printing on 50 sheets of paper when the number of sheets to be printed per minute is 50 pages per minute (PPM), for example, will be described.

In Act A1, the calculating section 27 obtains pixel count information from the system. The MFP 10 obtains the pixel count information on all the sheets to be printed before the start of printing. The system refers to the control system 51.

In Act A2, the calculating section 27 obtains or calculates a necessary toner replenishment time from the pixel count information on each of the four color components. For example, the calculating section 27 obtains or calculates that a toner replenishment time from the toner cartridge 16Y to the developing device 25 for yellow is 50 seconds.

As for the toner replenishment time, by measuring the amount of replenishment toner dripped into the developing device 25, an appropriate value of the toner replenishment time is obtained. Moreover, each of the toner replenishment times of magenta, cyan, and black toner is measured and determined in advance, and, in Act A2, the calculating section 27 calculates each value. For example, the calculating section 27 calculates that each of the toner replenishment times of four colors is 50 seconds.

Then, in Act A3, the calculating section 27 calculates the time at which printing is ended, based on: the time of the start of printing, the number of sheets to be printed and the printing speed.

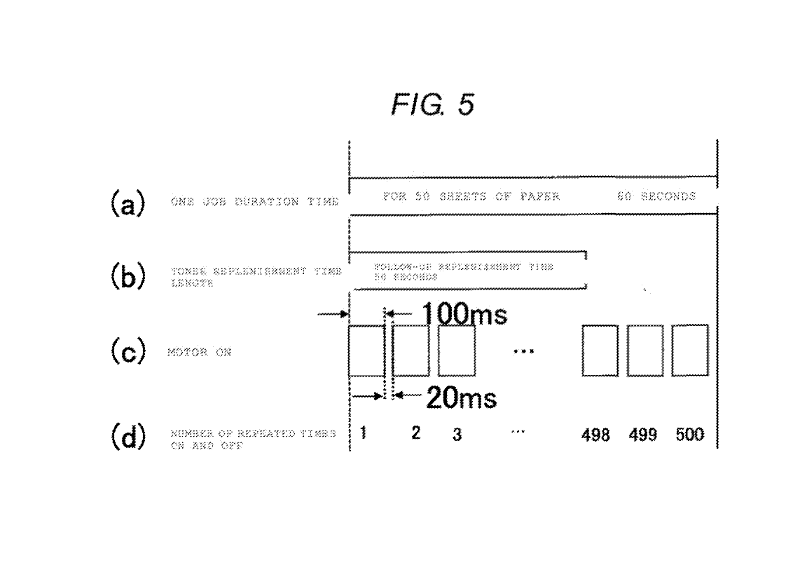

FIG. 5 is a time chart of toner replenishment performed by the calculating section 27 and the drive control, section 28. The calculating section 27 calculates the time at which a print job is ended from the information indicating that the number of sheets to be printed is 50, and, as depicted in (a) of FIG. 5, obtains a job duration time of one print job. A job duration time of one print job for printing 50 sheets is determined to be 60 seconds, for example. In (b) of FIG. 5, a follow-up replenishment time as the toner replenishment time obtained in Act A2 is set at 50 seconds.

Then, in Act A4 of FIG. 4, the calculating section 27 and the drive control section 28 perform calculation by which a toner replenishment time of 50 seconds is equally divided into a plurality of parts and determine an operation-ON period and an operation-OFF period of the toner replenishment motor 47. In (c) of FIG. 5, a time chart of ON of the toner replenishment motor 41 is depicted. In (d) of FIG. 5, the number of times a rising edge of an ON signal of the toner replenishment motor 47 is repeated is depicted. In the example of (c) and (d) of FIG. 5, the drive control section 28 equally divides the toner replenishment time of 50 seconds into 500 parts and assigns 100 ms to the time of one toner divided replenishment operation. The division number is set at a value, in this case 500, that depends on the length of divided replenishment time.

A toner replenishment minimum unit, which is the divided replenishment time, is set at 100 ms by the calculating section 27 based on how much replenishment toner is supplied into the developing device 25 for the print job.

Moreover, when the toner replenishment motor 47 is turned off for 20 ms with respect to the toner replenishment minimum unit of 100 ms, 20 ms is a value that is set based on the toner replenishment minimum unit of 100 ms and the job duration time of (a) of FIG. 5. The toner replenishment minimum unit may be set with consideration given to the specifications of a stepping motor. The calculating section 27 makes the determination in a similar manner for the toner replenishment motors 47 of each of the different toner colors.

As a result of the determination, the MFP 10 repeats divided replenishment, one set of which is formed of an ON time of 100 ms and an OFF time of 20 ms, 500 times. To print all the pixels contained in 50 sheets of paper, the MFP 10 executes a total toner replenishment time length of 50 seconds by using the toner transporting section 26. The MFP 10 equally divides the total toner replenishment time length of 50 seconds into 500 parts over 60 seconds (the duration of the print jobs of 50 sheets of paper), and repeats divided replenishment using the toner transporting section 26, 500 times. With the divided replenishment, nonuniform toner concentration in the developing device 25 can be prevented. With the MFP 10, even when the developing device 25 is small, the execution of the divided replenishment prevents agitation performed inside the developing device 25 from becoming inadequate and can stabilize the toner concentration. A sequence of divided replenishment as depicted in FIG. 5 can be created before printing is started and the toner concentration can be made uniform during printing, whereby image quality is stabilized.

Moreover, after one print job is ended, the MFP 10 performs normal toner replenishment control until a next print job is started. The MFP 10 reads detected voltages from the toner sensors 38 in the developing devices 25 in four places. If the MFP 10 determines that the toner concentration is lower than a threshold value by any one of the toner sensors 38, the MFP 10 changes the operation mode of the developing devices 25 to a forced toner replenishment mode and makes the toner transporting sections 26 perform toner replenishment. Accordingly, the toner concentration in each developing device 25 is maintained at a uniform toner concentration.

In general, as the developing container becomes smaller, agitation becomes inadequate and the toner concentration tends to be nonuniform. The conventional, image forming apparatus frequently suspends printing and enters forced toner replenishment operation, and the printing performance is degraded as compared to original printing performance. On the other hand, with the MFP 10 described in the present disclosure, since a toner lump or agglomeration is crushed by divided replenishment, the uniformity of the toner concentration in the developing device 25 can be maintained.

As described above, in the MFP 10, since pixel count information is obtained, before the start of printing of one job, a replenishment time required for the printing is calculated from, the pixel count information, and replenishment control is performed evenly throughout the replenishment time, development control can be performed more stably. Moreover, by calculating the ON time and the OFF time of the toner replenishment motor 47 based on the relationship between a job duration time between the start and end of printing and a toner replenishment time and changing the lengths of the ON time and the OFF time in accordance with the printing time (job duration time) and the amount of toner to be added (corresponding to a toner replenishment time length), replenishment of an equal amount of toner can be performed at the start of printing operation. Since the amount of toner to be added itself is an amount determined by the mechanisms such as the toner transporting section 26, the MFP 10 obtains the amount of toner to be added based on the toner replenishment time length.

Furthermore, based on the pixel count information and the number of sheets to be printed, the MFP 10 changes the intervals of ON and OFF of the toner replenishment motor 47 depending on whether an image read from a manuscript surface is dart or light. The image forming apparatus according to the embodiment differs from divided replenishment that merely performs replenishment of a constant amount of toner at regular intervals in that appropriate toner replenishment can be performed based on the pixel count and the number of sheets to toe printed.

### MODIFIED EXAMPLE

In the above-described control by which a replenishment time is equally divided in divided replenishment, one job duration time is assigned to 500 divided replenishment operations. However, in place of a lob duration time, the time required for printing and output of a single sheet of paper may be equally divided and divided replenishment may be executed in these periods of time.

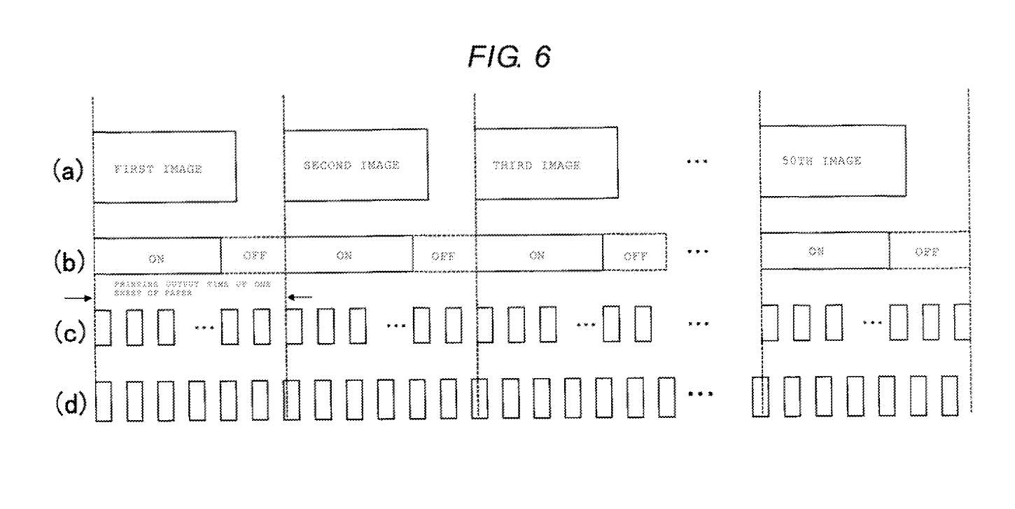

FIG. 6 is a time chart for describing divided replenishment operation performed by an image forming apparatus according to a modified example. In (a) of FIG. 6, an execution of image formation processing performed on a plurality of sheets of paper is shown. In (a) of FIG. 6, an example obtained by expanding the duration depicted in (a) of FIG. 5 into individual sheets to be printed is shown. In (b) of FIG. 6 which indicates whether toner divided replenishment is being executed (ON) or not (OFF), a time chart of ON and OFF of replenishment operation for each sheet of paper is shown. In (b) of FIG. 6, an example obtained by expanding the duration depicted in (b) of FIG. 5 is shown.

In (c) of FIG. 6, control timing of divided replenishment in which the time is divided equally, the divided replenishment performed by the image forming apparatus according to the modified example, is shown. A mark (a rectangle) represents a state in which replenishment is being performed. In (d) of FIG. 6, an example obtained by spreading a signal of (c) of FIG. 5 over the entire job duration time is depicted. As depicted in (c) of FIG. 6, the drive control section 28 equally divides a total toner replenishment time length (a follow-up replenishment time) into a plurality of parts for each sheet of paper. The drive control section 28 obtains a printing output time for each sheet of paper by dividing one job duration time by 50, which is the number of sheets to be printed. The drive control section 28 obtains another toner replenishment time length for each sheet of paper by dividing a total toner replenishment time length by 50, which is the number of sheets to be printed. The drive control section 28 equally divides the obtained other toner replenishment time length in the printing output time for each sheet of paper and executes replenishment control. In this way, the MFP 10 can change an interval in which divided replenishment is executed in one job duration time, depending on the toner replenishment required for each sheet printed in the print job.

Incidentally, the embodiment is not limited to the embodiment described above and may be embodied after the component elements thereof are modified in the implementation phase without departing from the spirit thereof. In the embodiment described above, the toner conveyance path of the toner transporting section 26 is the tube 45, but the toner conveyance path is not limited to the tube 45. It goes without saying that replacements with various toner conveyance cross-section structures can also be used. The rotary agitation member 46 driven by a motor may be provided in the toner conveyance path. The rotary agitation member 46 may receive a turning force from a coupler, which is set in a space inside the body of the MFP 10 in place of the toner replenishment motor 47.

When a toner replenishment time is measured in advance, the influence of toner itself exists. The degree of agglomeration of a toner lump differs depending on the temperature at the time of storage of toner. The composition of the toner itself, for example, also is a factor for ease of conveyance of toner and a change in the length of a toner replenishment time. In the embodiment described above, the composition of toner itself is also accounted for, as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a latent image forming section configured to form an electrostatic latent image on an image carrying body based, on image data of a print job including a number of sheets to be printed for the print job and a pixel count of the print job;
a developing device configured to develop the electrostatic latent image with a two-component developer containing toner and a carrier;
a toner cartridge configured to provide replenishment toner to the developing device;
a toner transporting section configured to transport replenishment toner from the toner cartridge to the developing device;
a calculating section configured to calculate a toner replenishment time required for the toner transporting section to transport, the replenishment toner to the developing device based on the pixel count of the print job, and to calculate a job duration of the print job based on the number of sheets to be printed; and
a drive control section configured to control the toner transporting section to transport replenishment toner during each of a plurality of divided replenishment times, wherein the total of the plurality of divided replenishment times is equal to the toner replenishment time calculated by the calculating section, and the plurality of divided replenishment times are uniformly spread across the job duration.

2. The image forming apparatus according to claim 1, wherein
the drive control section controls the toner transporting section so that each of the plurality of divided replenishment times refers to on an ON period of transportation operation performed by the toner transporting section and obtained by equally dividing the toner replenishment time length by a predetermined number, each ON period being followed by an OFF period of transportation operation, wherein the total number of ON and OFF periods of transportation operation equals the job duration.

3. The image forming apparatus according to claim 2, wherein the predetermined number is based on how much replenishment toner is needed for the print job.

4. The image forming apparatus according to claim 2, wherein
the drive control section obtains a printing output time for each sheet to be printed in the print job, obtains a single-page toner replenishment time length for each sheet of paper by dividing the toner replenishment time length by the number of sheets to be printed, and calculates the plurality of divided replenishment times for each sheet to be printed in the print job based on the respective single-page toner replenishment time length uniformly spread across the respective printing output time for each sheet to be printed in the print job.

5. The image forming apparatus according to claim 4, wherein the printing output time for each sheet to be printed in the print job is obtained by dividing the job duration by the number of sheets to be printed contained in the print job.

6. The image forming apparatus according to claim 1, wherein
the calculating section calculates in advance an amount of toner to be transported per unit time by the toner transporting section and calculates the toner replenishment time based on the amount of toner to be transported,

7. The image forming apparatus according to claim 1, wherein
the toner transporting section includes a tube connected to an outlet of the toner cartridge and a supply opening of the developing device, a rotary agitation member feeding the replenishment toner into the tube through the outlet, provided in the toner cartridge, and a motor that rotates the rotary agitation member, and
an amount of toner to be transported by the toner transporting section per unit time is estimated in advance based on an inside diameter of the tube, an amount of toner to foe discharged and transported by one rotation of the rotary agitation member, and a rotation angular speed of the motor.

8. An image forming method comprising:
forming an electrostatic latent image on an image carrying body based on image data of a print job including a number of sheets to be printed for the print job and a pixel count of the print job;
developing the electrostatic latent image in a developing device with a two-component developer containing toner and a carrier;
calculating a toner replenishment time required to transport replenishment toner to the developing device based on the pixel count of the print job, and to calculate a job duration of the print job based on the number of sheets to be printed; and
transporting replenishment toner during each of a plurality of divided replenishment times, wherein the total of the plurality of divided replenishment times is equal, to the toner replenishment time calculated by the calculating section, and the plurality of divided replenishment times are uniformly spread across the job duration.

9. The method according to claim 8, wherein
each of the plurality of divided replenishment times refers to on an ON period of transportation operation performed by a toner transporting section and obtained by equally dividing the toner replenishment time length by a predetermined number, each ON period being followed by an OFF period of transportation operation, wherein the total number of ON and OFF periods of transportation operation equals the job duration.

10. The method, according to claim 9, wherein
the toner transporting section includes a tube connected to an outlet of the toner cartridge and a supply opening of the developing device, a rotary agitation member feeding the replenishment toner into the tube through the outlet, provided in the toner cartridge, and a motor that rotates the rotary agitation member, and
an amount, of toner to be transported by the toner transporting section per unit time is estimated in advance based on an inside diameter of the tube, an amount of toner to be discharged and transported by one rotation of the rotary agitation member, and a rotation angular speed of the motor.

11. The method according to claim 9, wherein the predetermined number is based on how much replenishment toner is needed for the print job.

12. The method according to claim 9, further comprising:
obtaining a printing output time for each sheet to be printed in the print job; and
obtaining a single-page toner replenishment time length for each sheet of paper by dividing the toner replenishment time length by the number of sheets to foe printed, wherein
the plurality of divided replenishment times for each sheet to be printed in the print job is calculated based on the respective single-page toner replenishment time length uniformly spread across the respective printing output time for each sheet to be printed in the print job.

13. The method, according to claim 12, wherein the printing output time for each sheet to foe printed in the print job is obtained by dividing the job duration by the number of sheets to be printed contained in the print job.

14. The method, according to claim 8, wherein
the toner replenishment time is calculated based on a predetermined, amount of toner to be transported per unit time.

15. An image forming apparatus comprising:
a latent image forming section configured to form an electrostatic latent image on an image carrying body based on image data of a print job including a number of sheets to be printed for the print job and a pixel count of the print job;
a developing device configured to develop the electrostatic latent image with a two-component developer containing toner and a carrier;
a toner cartridge configured to provide replenishment toner to the developing device;
a toner transporting section configured to transport replenishment toner from the toner cartridge to the developing device;
a calculating section configured to calculate a toner replenishment time required for the toner transporting section to transport the replenishment toner to the developing device based on the pixel count of the print job, and to calculate a job duration of the print job based on the number of sheets to be printed; and
a drive control section configured to control the toner transporting section to transport replenishment toner during each of a plurality of divided replenishment times that each refer to on an ON period of transportation operation performed by the toner transporting section and obtained by equally dividing the toner replenishment time length by a predetermined number, each OM period being followed by an OFF period of transportation operation, wherein the total number of ON and OFF periods of transportation operation equals the job duration, and the plurality of divided replenishment times are uniformly spread across the job duration.

16. The image forming apparatus according to claim 15, wherein the predetermined number is based on how much replenishment toner is needed for the print job.

17. The image forming apparatus according to claim 16, wherein
the drive control section obtains a printing output time for each sheet to be printed in the print job, obtains a single-page toner replenishment time length for each sheet of paper by dividing the toner replenishment time length by the number of sheets to be printed, and calculates the plurality of divided replenishment times for each sheet to be printed in the print job based on the respective single-page toner replenishment time length uniformly spread across the respective printing output time for each sheet to be printed, in the print job.

18. The image forming apparatus according to claim 17, wherein the printing output time for each sheet to be printed in the print job is obtained by dividing the job duration by the number of sheets to be printed contained in the print job.

19. The image forming apparatus according to claim 15, wherein
the calculating section calculates in advance an amount of toner to be transported per unit time by the toner transporting section and calculates the toner replenishment time based on the amount of toner to be transported.

20. The image forming apparatus according to claim 15, wherein
the toner transporting section includes a tube connected to an outlet of the toner cartridge and a supply opening of the developing device, a rotary agitation member feeding the replenishment toner into the tube through the outlet, provided in the toner cartridge, and a motor that rotates the rotary agitation member, and
an amount of toner to be transported by the toner transporting section per unit time is estimated in advance based on an inside diameter of the tube, an amount of toner to be discharged and transported by one rotation of the rotary agitation member, and a rotation angular speed of the motor.
